(19) United States
(12) Patent Application Publication
(10) Pub. No.: US 2019/0257120 A1
(43) Pub. Date: Aug. 22, 2019

(54) Bulk Vending Locking System

(71) Applicant: Thomas J. DiVito, Southington, CT (US)

(72) Inventor: Thomas J. DiVito, Southington, CT (US)

(21) Appl. No.: 15/900,199

(22) Filed: Feb. 20, 2018

(51) Int. Cl. E05B 65/00

(52) U.S. Cl. CPC E05B 65/006

(57) ABSTRACT

The disclosed lock enables the dome of a bulk vending machine to be secured and unlocked in fewer revolutions. The lock assembly is formed with a female thread at its end that uses multiple leads. The hopper rod of the machine is formed with the corresponding male threads matching the multiple leads of the lock assembly. The multiple leads engage sooner that the traditional single lead thread current in use. The multiple leads also reduce the repetitive motion fatigue that results from opening several machines.

### BACKGROUND OF THE INVENTION

The present invention relates to a locking system specifically found on bulk vending machines. Bulk vending machines are typically designed with a clear hopper to display the merchandise for sale. The hopper sits atop a base mechanism that accepts payment and dispenses the product after payment is accepted. A dome sits atop the clear hopper to enable product to be refilled or replaced. A keyed lock is placed within a centrally formed cavity of the dome. On the rear end of the lock are threads. One end of the hopper rod is affixed to the base mechanism so that is positioned in the center of the hopper and aligns with the rear end of the lock inside the dome. The hopper rod is retained in the mechanism so it cannot rotate. When the proper key is presented to the lock and rotated, the stator section of the lock remains held in place by the shape of the dome and the rotor lock component turns and the threads of the lock and engage the hopper rod. During the securing of the dome the key will need to rotate approximate four complete revolutions before the dome will fit snugly on the hopper. Likewise, the unlocking function will require approximately four complete revolutions to allow the dome to be removed.

Bulk vending machines are usually placed in groups vending a variety of items in each location. The service person needs to open and close each machine when refilling, collecting payments, or servicing the units. This requires a lot of time and the repetitive motion places a strain on the person performing the services.

Prior art shows complicated solutions to allow the machines to be opened and closed with less time and effort. They have been shown to not be economically feasible or operationally practical and the industry continues to use the standard method. The standard method involves rod and lock threads that are ¼″−20 tpi-single lead.

### SUMMARY OF THE INVENTION

One embodiment provides a lock and hopper rod with matching multiple thread leads to significantly reduce the number of complete revolutions required for either opening or closing the dome. For example, threads with double leads will require only half the number of revolutions. Quad lead threads will require only one revolution.

A second embodiment provides a solution to the many machines already placed in service. An additional adaptor component is configured to fit between the existing lock assembly and hopper rod. The adaptor component would attach to an existing hopper rod using the standard thread at one end with the opposite end having a multiple lead thread. The multiple lead thread end would be a larger diameter thread than the existing hopper rod. The thread in the rear of the lock would then be tapped to the new multiple thread configuration that matched the adaptor. This method would allow existing machines and locks to be converted and not need replacement.

Briefly stated, a locking system for a bulk vending machine, in one embodiment, employs a lock which comprises a stator and a rotor having a female thread. The lock is openable by a key. A hopper rod has a male thread threadably engageable with the rotor thread. The female thread and the male thread are multiple lead threads. In one embodiment, the female thread and the male thread are quad D threads.

A locking system for a bulk vending machine, in another embodiment comprises a lock openable by a key with a stator and a rotor having a female thread. A hopper rod has a male thread. An adaptor connects the rotor and the hopper rod. The adaptor has an external thread engageable with the female thread and an internal thread engageable with the hopper rod thread. The rotor female thread has a multiple lead thread and the external thread is a multiple lead thread engageable with the female thread or the internal thread has a multiple lead thread and the male thread is a multiple lead thread engageable with the adaptor internal multiple lead thread.

The rotor female thread and the external adaptor thread are each a multiple lead thread. The rotor female thread and the external adaptor thread are each a quad lead thread in one embodiment. The adaptor internal thread and the hopper rod thread are each a single lead thread in one embodiment. The rotor female thread and the adaptor exterior thread are each a single lead thread, and the adaptor interior thread and the hopper rod male thread are each a multiple lead thread. The adaptor female thread and the hopper rod thread are each a quad thread lead in one preferred embodiment.

A method for improving the lock system of a bulk vending machine comprises implementing a threaded engagement which connects a lock rotor and a hopper rod via a multiple lead male thread and a multiple lead female thread engagement. The method further comprises inserting an adaptor between the lock rotor and the hopper rod. The method further comprises forming a multiple lead thread in the lock rotor. In one embodiment of the method, the method further comprises tapping a multiple lead thread on the hopper rod.

### BRIEF DESCRIPTION OF THE DRAWINGS

FIG. 1 is a perspective view showing a keyed lock assembly and fully engaged hopper rod as is typically installed in a bulk vending machine;

FIG. 2 is a frontal view showing a key, a lock assembly, and hopper rod;

FIG. 3 is a cutaway section of the frontal view of the lock assembly showing the stator and rotor components;

FIG. 4 is rear view of the lock assembly;

FIG. 5 is a perspective view of an adaptor;

FIG. 6 is a front view of the adaptor;

FIG. 7 is a side view of the adaptor (the top bottom and opposite side looking similar);

FIG. 8 is a cutaway section of the frontal view of the adaptor;

FIG. 9 is a rear view of the adaptor;

FIG. 10 is a perspective view of a keyed lock assembly, an adaptor, and a hopper rod.

FIG. 11 is a perspective view of an alternate adaptor;

FIG. 12 is a front view of the alternate adaptor;

FIG. 13 is a side view of the alternate adaptor;

FIG. 14 is a rear view of the alternate adaptor;

FIG. 15 is a cutaway section of the side view of the alternate adaptor; and

FIG. 16 is a representative bulk vending machine principally shown in broken lines with a representative locking system shown in solid lines for which the present invention has particular application.

### DETAILED DESCRIPTION

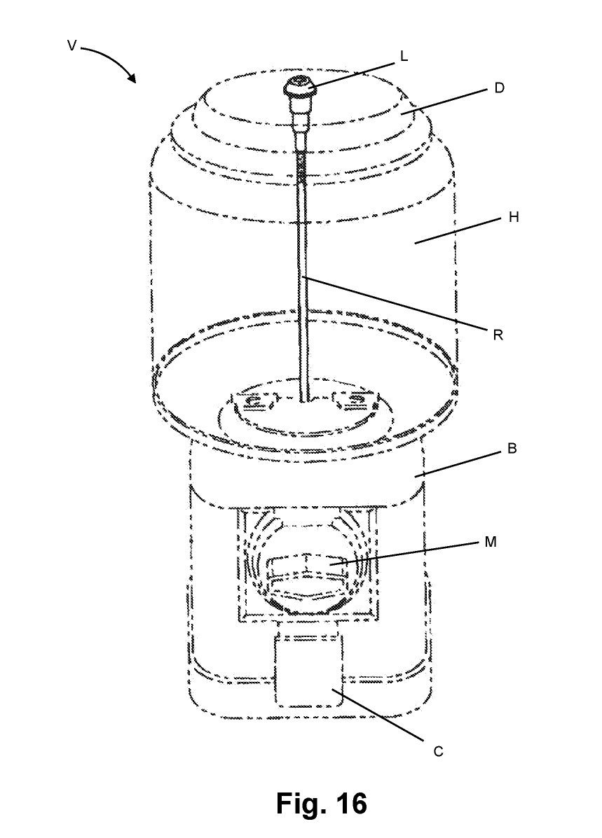

With reference to the drawings wherein like numerals represent like parts throughout the figures, an improved locking system has particular application in connection with a bulk vending machine V of a type such as represented in FIG. 16. The bulk vending machine V employs a transparent hopper H which displays and contains merchandise for sale. The hopper H is disposed atop a base B which includes a mechanism M that accepts a payment and dispenses the product through a dispenser or chute C after payment is accepted.

A dome D typically is disposed on top of the hopper and is removable to allow the hopper to be refilled or, in some instances, replaced. A key lock L is placed within a centrally formed cavity of the dome D and ultimately connects via a hopper rod R which, in turn, is affixed to the base B to lock the dome D to the base B. The hopper rod R is retained in the mechanism M so that it typically cannot rotate.

The proper key (not illustrated in FIG. 16) is presented to the lock and rotated. The center section of the lock remains fixed by the shape of the dome and the rotor lock component of the lock assembly and turns, and the threads of the lock engage the hopper rod. When the key is rotated in one direction which is typically four complete revolutions, the dome will fit snugly on the hopper. When the key is rotated in the counter direction, the unlocking function requires the multiple revolutions to allow the dome D to be removed.

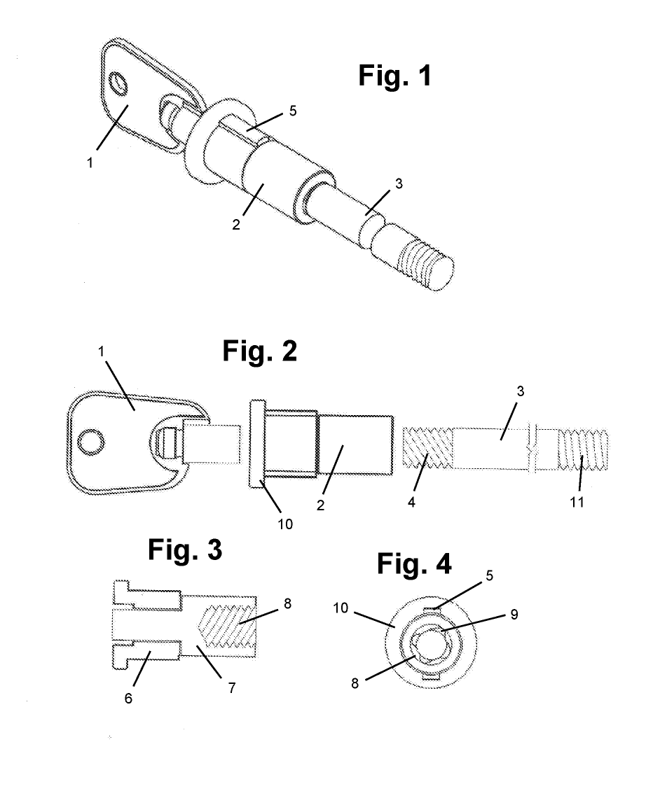

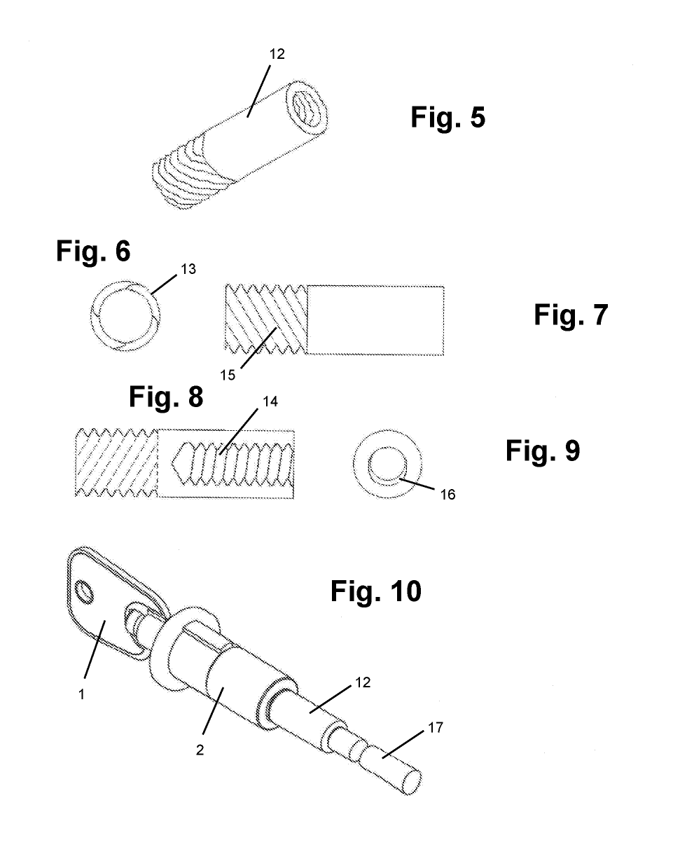

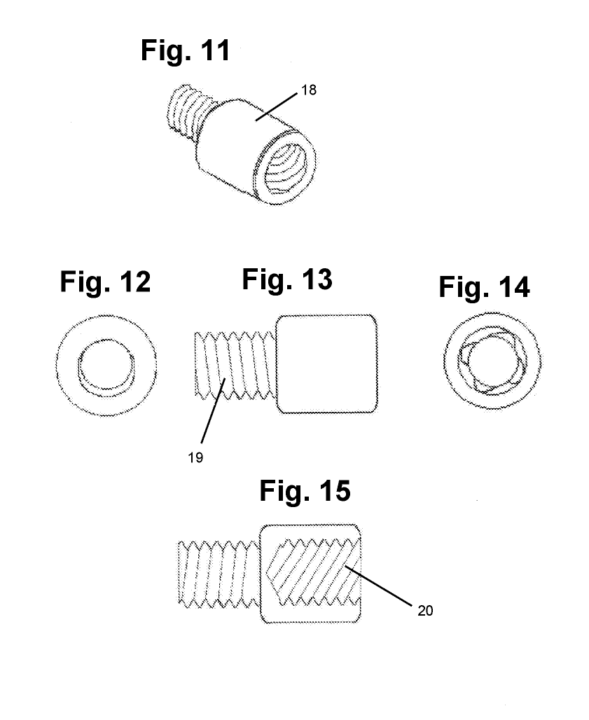

Three embodiments of an improved locking system are disclosed. One locking system embodiment is illustrated in FIGS. 1-4. A second locking system embodiment is illustrated in FIGS. 5-10 and a third locking system embodiment is illustrated in FIGS. 11-15.

With reference to FIGS. 1-4, a properly coded key 1 is required to operate the lock assembly 2. The lock assembly 2 has orientating flats 5 to maintain a fixed position within the dome D of a bulk vending machine V. When the dome D is properly secured to a hopper H, the hopper rod 3 will be fully seated within the lock assembly.

When an unsecured lock is placed in a dome, it will first make contact with the top of the hopper rod. 3. A lock assembly 2 is generally comprised of a stator 6 and a rotor 7. As a properly coded key 1 is rotated within the lock assembly 2, the rotor 7 will correspondingly move to engage the rotor female threads 8 and the male threads 4 on the top of the hopper rod 3. The hopper rod 3 is fixed in place on its base by male threads on the bottom of the hopper rod 11. The engagement of the rotor threads 8 and the hopper rod threads 4 functions to draw the lock onto the fixed hopper rod 3. When the key is turned sufficiently, the shoulder of the lock assembly 10 will compress into the dome and create a tight seal. The thread of the rotor and top thread of the hopper rod being configured with a multiple lead will cause the lock assembly to draw down into the dome with less revolutions that using a single lead thread.

For illustration purposes, the thread of the rotor 8 is shown with four leads 9. A dual lead thread or other multiple lead thread is possible. The threads of lock rotors will be configured to match the multiple leads of the hopper rod. Custom taps can be made to fit this requirement.

With reference to FIGS. 5-10, to facilitate the application of this improvement to an existing bulk vending machine using all of its existing parts, a new adaptor 12 is shown. The adaptor would fit between the lock assembly 2 and the existing hopper rod 17. The external threads on the adaptor 15 would have multiple leads. Four leads 13 are shown in FIG. 6. The internal thread of the adaptor 14 would match the existing hopper rod design using one lead 16. The existing hopper rod 17 will bottom inside the adaptor and create a new length for the lock to engage. There is sufficient room in the bases of many bulk vending machines for the existing hopper rod to be lowered to accommodate this additional length.

The thread in the rotor of the lock must be reconfigured to accommodate the multiple leads of the adaptor. This involves drilling the existing lock threads to accommodate a new multiple lead tap.

With reference to FIGS. 11-15, an alternate adaptor 18 also allows current lock systems to be improved. The adaptor 18 would fit between the lock 2 and a new hopper rod 3. The illustration of this assembly would be similar to FIG. 10. The lock 2 would not have its rotor thread altered. The alternate adaptor 8 would replace the adaptor 12 in FIG. 10. The male thread 19 of the alternate adaptor 18 will match the single lead female rotor thread of the existing lock. The existing hopper rod 17 would be replaced by the new hopper rod 3. The female thread of the alternate adaptor 20 would be configured with multiple leads to match the male thread 4 on top of the new hopper rod.

It is possible that for some embodiments, the male/female multiple thread configurations on the rotor and the hopper rod and/or adaptors could be reversed in relation to the previously described embodiment.

While preferred embodiments of the foregoing locking system have been set forth for purposes of illustration, the foregoing description should not be deemed a limitation of the invention herein. Accordingly, various modifications, adaptations and alternatives may occur to one skilled in the art without departing from the spirit and the scope of the present invention.

1. A locking system for comprising:
a bulk vending machine comprising:
a base comprising a payment mechanism and a dispenser;
a hopper disposed on said base;
a cover disposed on said hopper and removably closeable against said hopper;
a lock mounted to said cover and comprising a stator and a rotor having a female thread and being openable by a key, said lock locking said cover to said hopper and base;
a hopper rod extending through said hopper and affixed to the base having a male thread threadably engageable with said rotor threads;
wherein said female thread and said male thread are each a multiple lead thread.

2. The locking system of claim 1 wherein said female thread and said male thread are each a four quad lead thread.

3. A locking system for locking said cover to said hopper and said base comprising:
a bulk vending machine comprising:
a base comprising a payment mechanism and a dispenser;
a hopper disposed on said base;
a cover disposed on said hopper and removably closeable against said hopper;
a lock mounted to said cover openable by a key and comprising a stator and a rotor having a female thread locking said cover to said hopper and said base;
a hopper rod extending through said hopper and affixed to the base having a male thread;
an adaptor connecting said stator and said hopper rod and having an external thread engageable with said female thread and an internal thread engageable with the hopper rod thread;
wherein said rotor female thread has a multiple lead thread and said external thread is a multiple lead thread engageable with said female thread or said internal thread is a multiple lead thread and said male thread is a multiple lead thread engageable with said adaptor internal multiple lead thread.

4. The locking system of claim 3 wherein said rotor female thread and said external adaptor thread are each a multiple lead thread.

5. The locking system of claim 4 wherein said rotor female thread and said external adaptor thread are each a quad lead thread.

6. The locking system of claim 3 wherein said adaptor internal thread and said hopper rod thread are each a single lead thread.

7. The locking system of claim 3 wherein said rotor female thread and said adaptor exterior thread are each a single lead thread and said adaptor internal thread and said hopper rod thread are each a multiple lead thread.

8. The locking system of claim 7 wherein said adaptor internal thread and said hopper thread are each a quad lead thread.

9. A method for improving the lock system of a bulk vending machine comprising a base comprising a payment mechanism and a dispenser, a hopper disposed on the base and a cover disposed on the hopper and removably closeable against the hopper and having a hopper rod which locks the cover to the base, said method comprising:
implementing a threaded engagement which connects a lock rotor and a hopper rod via a multiple lead male thread and multiple lead female thread engagement.

10. The method of claim 9 further comprising inserting an adaptor between said lock rotor and said hopper rod.

11. The method of claim 9 further comprising forming a multiple lead thread in said lock rotor.

12. The method of claim 9 further comprising tapping a multiple lead thread on said hopper rod.
